(19) United States
(12) Patent Application Publication
(10) Pub. No.: US 2026/0338187 A1
(43) Pub. Date: Oct. 29, 2026

(54) COLLAR FOR SCREW PUMP

(71) Applicant: BERRY BEAUTE MAROLLES SAS, Marolles Les Braults (FR)

(72) Inventor: Christophe ANDRIEUX, Marolles Les Braults (FR)

(21) Appl. No.: 19/117,828

(22) PCT Filed: Oct. 2, 2023
(86) PCT No.: PCT/EP2023/077283

§ 371 Date: Apr. 2, 2025

(30) Foreign Application Priority Data
Oct. 4, 2022 (GB) 2214557.7

(51) Int. Cl. F04C 29/00; B65D 1/02; B65D 47/00

(52) U.S. Cl. CPC F04C 29/00; B65D 1/0246; B65D 47/00

(57) ABSTRACT

A collar (110) for retaining a pump is provided. The collar (110) comprises a generally cylindrical sidewall (115) open at both ends and into which a pump can be received. The interior of the sidewall (115) is provided with one or more circumferential friction ribs (140a, 140b) which provide friction against a pump in use.

The present invention relates generally to pumps and particularly, although not exclusively, to a collar for a pump.

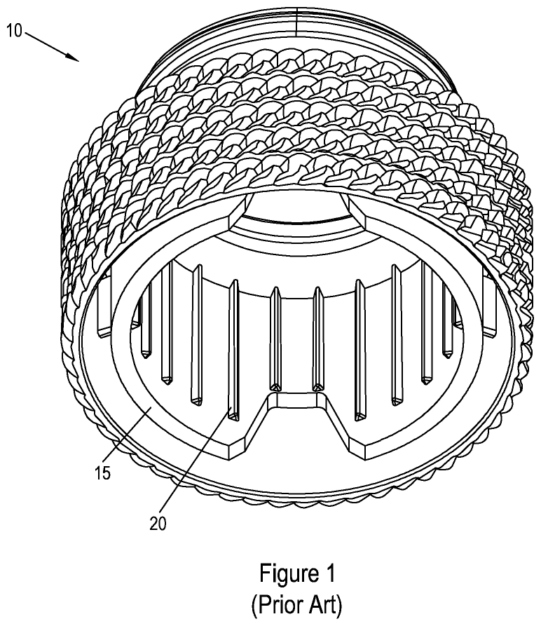

Today, similar collars are already on the market on a crimp pump—see e.g. FIG. 1.

The collar 10 shown in FIG. 1 comprises an inner cylindrical sidewall 15 which includes a plurality of axially extending ribs 20.

There is a desire to change the pump to have the possibility of use with a refillable bottle.

The present inventors have found that this known collar 10 does not assemble well on a screw pump (refillable pump). There needs to be a big interaction between collar and pump to don't have a movement between them, because if the collar turns on the pump it is not possible to unscrew the pump to refill the bottle. This big interaction impacts the assembly force; it is necessary push with 30 kg while typically 15 kg is used. Moreover, due to the shape of the cap, this high assembly force can put the cap cocked or “wonky”. So, there is a desire to improve the existing collar to come back to a good assembly.

Some embodiments of the present invention are directed to solve an assembly problem between a collar and a pump. The pump doesn't stay right during the assembly. This problem impacts the assembly and disassembly force.

The present invention seeks to provide improvements in or relating to pump collars.

An aspect of the present invention provides a collar for retaining a pump, the collar comprising a generally cylindrical sidewall open at both ends and into which a pump can be received, in which the interior of the sidewall is provided with one or more upstanding circumferential friction ribs which provide friction against a pump in use.

The general idea of the present invention involves a pump for a refillable container which is securable (e.g. screwed) to a container. The collar is attached to the pump such that the collar and the pump act as a single element (and thus a user can unscrew the pump using the collar).

Circumferential (“horizontal”) ribs/strips can be used to prevent relative (axial) sliding between a collar and a pump.

The number and spacing of the ribs/strips could be changed and selected to provide a required function (e.g. a level of friction).

In some embodiments the or each rib extends continuously. In other embodiments the or each rib is segmented.

In some embodiment only two ribs are provided. In other embodiments only four ribs are provided.

The “height” of the ribs may be selected to balance between providing sufficient friction and being able relatively easily to demould the collar.

In one embodiment, for example, the friction rib/s may project from the surface of the sidewall by approximately 0.03 mm. For example, the friction rib/s may project from the surface of the sidewall by 0.03 mm.

The collar may further comprise a plurality of axially extending anti-rotation ribs.

In some embodiments of the present invention the idea is to put inside the collar some vertical strips in additional to horizontal strips. These new strips will help the collar doesn't turn on the pump and with that it is possible to reduce the interaction between the two parts and reduce the assembly force.

In some embodiments the inner part of the collar comprises vertical strips (with e.g., a particular arrangement between them) configured to improve the attachment between the collar and the pump.

In some embodiments the sidewall has a pump actuator end and a pump closure end, and the anti-rotation ribs are located towards the pump actuator end.

The sidewall may comprise a radially inwardly inclined portion, and the anti-rotation ribs may be located on the portion.

The pump actuator end of the sidewall may be provided with engagement means (such as a snap bead or a screw thread formation) for receiving a cover (a cap or a hood, for example).

The collar may further comprise an outer skirt.

An outer skirt may, for example, extend from a position on the exterior of the sidewall which is axially below an axial rib bearing inclined portion.

The collar is formed from a plastics material, such as polypropylene (PP).

In some embodiments the collar is provided as a single piece article.

In some embodiments the collar is configured or adapted for use with a screw-on spray pump.

A further aspect provides a dispensing assembly comprising a pump and a retaining collar, the pump comprises an actuator part and a closure part, the pump closure part comprising a closure sidewall provided with engagement means for engaging a container, the collar comprises a collar sidewall, the interior of the collar sidewall is provided with one or more circumferential ribs which provide friction against the exterior of the pump closure sidewall.

The pump may be a screw-on pump. The pump closure part may comprise a screw thread formation for engaging a container.

A further aspect provides a refillable dispensing system comprising a screw-on a pump, a collar and a refillable bottle, the pump and the bottle comprise cooperating screw thread formations, the collar comprises a collar sidewall, the interior of the collar sidewall is provided with one or more annular ribs for resisting relative axial movement with the pump engaged in the collar.

Although illustrative embodiments of the invention have been disclosed herein, it is understood that the invention is not limited to the embodiments shown and that various changes and modifications can be effected therein by one skilled in the art without departing from the scope of the invention.

Different aspects and embodiments of the invention may be used separately or together.

The present invention is more particularly shown and described, by way of example, in the accompanying drawings.

All orientational terms, such as upper, lower, radially and axially, are used in relation to the drawings and should not be interpreted as limiting on the invention or its connection to a closure.

Example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed and as well as individual embodiments the invention is intended to cover combinations of those embodiments as well. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent; however, the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

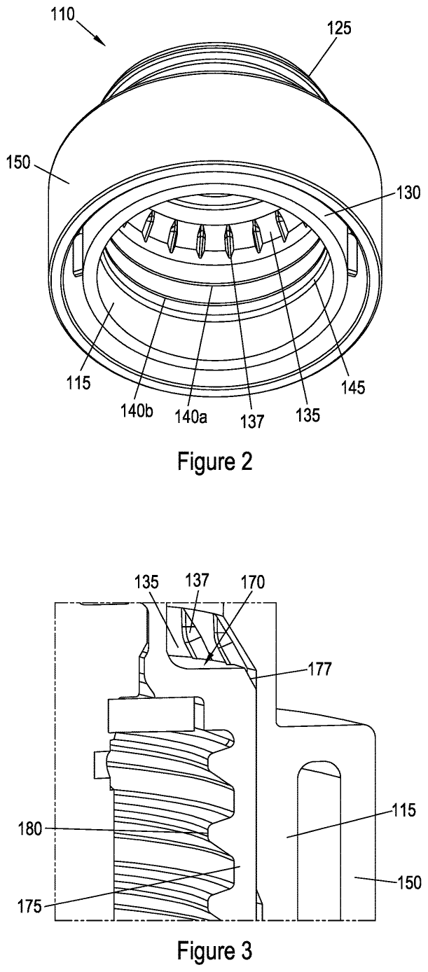

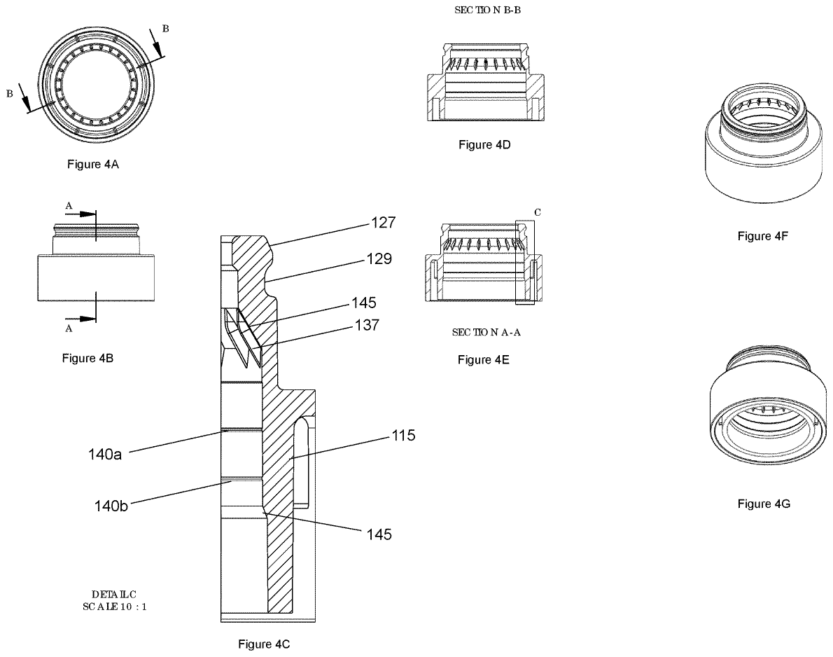

Referring to FIGS. 2 to 4 there is shown a collar generally indicated 110. The collar 110 comprises a generally cylindrical inner sidewall 115 with a generally circular section.

The sidewall 115 is open at both ends: first end 125 (which could also be referred to as a pump actuator end) and a second end 130 (which could also be referred to as a pump closure end).

The first end 125 comprises a rim 127 and an annular recess 129. This allows a cap (not shown) to be fitted onto the collar.

Towards the second end 130 the interior of the sidewall 115 narrows with a first inclined portion 145

Towards the first end 125 the interior of the sidewall 115 narrows with a second inclined portion 135. A plurality of spaced, axial (“vertical”) anti-rotation ribs 137 are provided on the inclined portion 135.

Axially between the inclined portions 135, 145 the sidewall 115 is provided with two (in this embodiment) mutually spaced circumferential “bumps” or friction ribs 140a, 140b. Depending on the result, the number and spacing of the ribs can be changed.

The collar also comprises an outer sidewall or skirt 150 connected to the inner sidewall just below the inclined portion 135.

In use the collar is assembled with a pump. FIG. 3 shows a closure part 170 of a pump, which includes a side skirt 175 having a shoulder 177 at one end thereof. The skirt 175 has a screw thread formation 180 so that the pump can be screwed onto a container.

The pump is fitted into the collar (or the collar could be pushed down onto the pump), with the pump passing through the end 130 into the interior of the sidewall 115 until the shoulder 177 engages the first inclined portion 135. The skirt 175 slides along the sidewall 115 and consequently over the bumps 140a, 140b.

The anti-rotation ribs 137 engage against the closure to help prevent relative rotation between the collar and the pump. The interaction between the closure skirt 175 and the bumps 140a, 140b provides increased friction to help resist relative axial sliding movement.

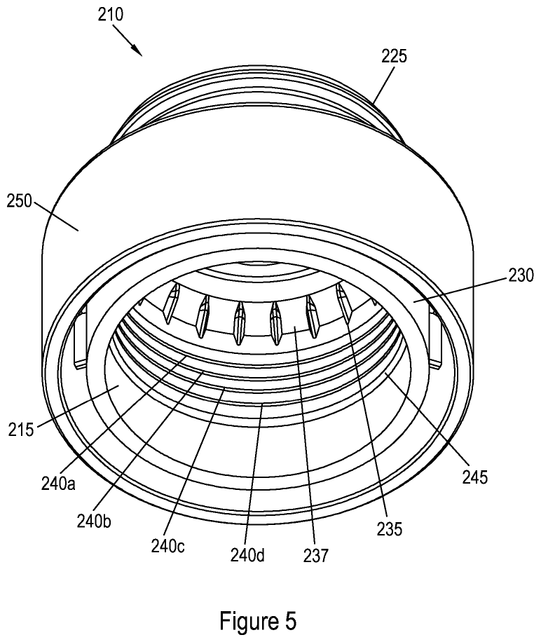

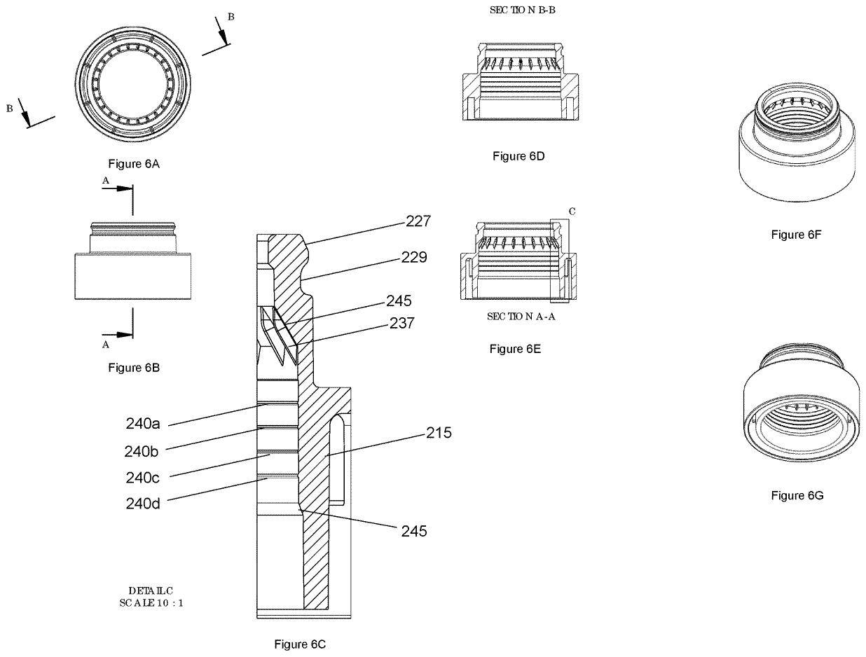

FIGS. 5 and 6 show a collar 210 formed according to a further embodiment. The collar 210 is similar to the collar 110. In this embodiment there are four mutually spaced circumferentially extending ribs 240a, 240b, 240c, 240d.

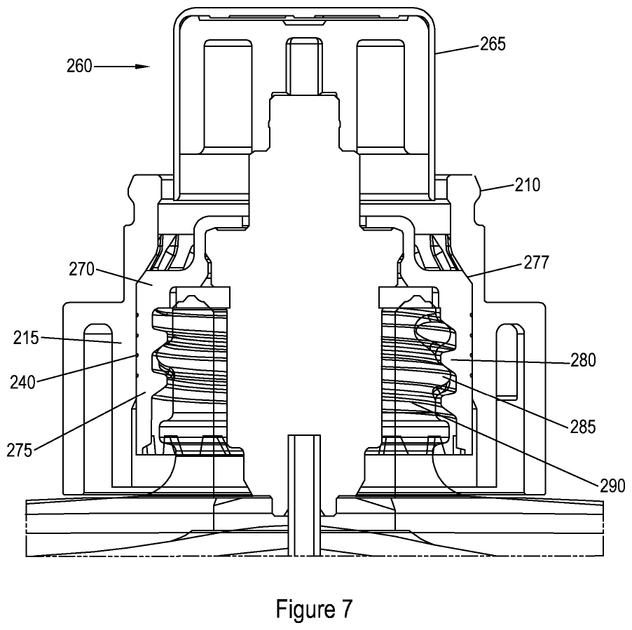

FIG. 7 shows the collar 210 assembled with a screw-on pump 260.

The pump 260 comprises an actuator part 265 and a closure part 270.

The closure part 270 comprises a skirt 275 with an internal screw thread formation 280 for engaging a cooperating formation 285 on a bottle 290.

The pump 260 is fitted into the collar 210, passing through the end 230 into the interior of the sidewall 215 until the shoulder 277 engages against the first inclined portion 235. The skirt 275 slides along the sidewall 215 and consequently over the bumps 240a-d.

The anti-rotation ribs 237 engage against the closure part 270 to help prevent rotation of the collar on pump. The interaction between the closure skirt 275 and the bumps 240a-d provides increased friction to help resist axial sliding movement.

This means that the collar 210 can be used to unscrew the pump 260 from the bottle 290, allowing re-filling of the bottle and subsequent replacement of the pump.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention.

1. A collar for retaining a pump, the collar comprising a generally cylindrical sidewall open at both ends and into which a pump can be received, in which the interior of the sidewall is provided with one or more circumferential friction ribs which provide friction against a pump in use.

2. A collar in according to claim 1, in which the or each rib extends continuously.

3. A collar according to claim 1, in which the or each rib is segmented.

4. A collar according to claim 1, in which two ribs are provided.

5. A collar according to claim 1, in which four ribs are provided.

6. A collar according to claim 1, in which the friction rib/s project from the surface of the sidewall by approximately 0.03 mm.

7. A collar according to claim 1, further comprising a plurality of axially extending anti-rotation ribs.

8. A collar according to claim 1, in which the sidewall has a pump actuator end and a pump closure end, and the anti-rotation ribs are located towards the pump actuator end.

9. A collar according to claim 1, in which the sidewall comprises a radially inwardly inclined portion, and the anti-rotation ribs are located on the portion.

10. A collar according to claim 1, in which the pump actuator end of the sidewall is provided with engagement means for receiving a cover.

11. A collar according to claim 1, further comprising an outer skirt.

12. A collar according to claim 11, in which the sidewall comprises a radially inwardly inclined portion, and the anti-rotation ribs are located on the portion, and in which the outer skirt extends from a position on the exterior of the sidewall which is axially below the inclined portion.

13. A collar according to claim 1, in which the collar is formed from a plastics material.

14. A collar according to claim 1, in which the collar is provided as a single piece article.

15. A dispensing assembly comprising a pump and a retaining collar, the pump comprises an actuator part and a closure part, the pump closure part comprising a closure sidewall provided with engagement means for engaging a container, the collar comprises a collar sidewall, the interior of the collar sidewall is provided with one or more circumferential ribs which provide friction against the exterior of the pump closure sidewall.

16. The dispensing assembly according to claim 15, in which the pump is a screw-on pump and the pump closure part comprises a screw thread formation for engaging a container.

17. A refillable dispensing system comprising a screw-on a pump, a collar and a refillable bottle, the pump and the bottle comprise cooperating screw thread formations, the collar comprises a collar sidewall, the interior of the collar sidewall is provided with one or more annular ribs for resisting relative axial movement with the pump when engaged in the collar.
